(19) United States
(12) Patent Application Publication
(10) Pub. No.: US 2026/0291301 A1
(43) Pub. Date: Sep. 24, 2026

(54) Stator Lamination Made of Steel Foil

(71) Applicant: BorgWarner Inc., Auburn Hills, MI (US)

(72) Inventors: David Fulton, Anderson, IN (US); Kirk Neet, Noblesville, IN (US)

(21) Appl. No.: 19/572,251

(22) Filed: Mar. 19, 2026

Related U.S. Application Data
(60) Provisional application No. 63/774,556, filed on Mar. 19, 2025.

(51) Int. Cl. H02K 1/16; H02K 1/02; H02K 15/0273; H02K 15/0278

(52) U.S. Cl. CPC H02K 1/16; H02K 1/02; H02K 15/0273; H02K 15/0278; H02K 2201/09; H02K 2213/03

(57) ABSTRACT

A stator core incorporates thin laminations and and/or higher silicon material in order to further reduce eddy current losses. The stator core may be made from super thin Ductile High Silicon Steel (DHSS). The DHSS is provided as a foil that may be less than fifty microns thick, such as ten microns to forty microns thick. The foil may also be made in ribbons which are twenty-five to fifty mm wide.

### CROSS-REFERENCE TO RELATED APPLICATIONS

This patent application claims priority to U.S. provisional patent application no. 63/774,556 filed Mar. 19, 2025, the entire contents of which are incorporated by reference herein.

### FIELD

This application relates to the field of electric machines and particularly, stators for electric machines.

### BACKGROUND

Conventional stator cores for traction motors and other electric machines are comprised of thin steel sheets called laminations. The laminations tend to be 0.2-0.3 mm thick and are stacked into a lamination stack which provides a core for the electric machine. The process to bond the laminations is typically either a weld on the outside diameter (OD) of the laminations or a bonding material between the laminations. Thin laminations are used because they break up the eddy current losses resulting in lower losses and a higher efficiency stator. Eddy current losses are further reduced with more layers of laminations.

The saturation flux density (or saturation induction) (i.e. “Bsat”) of the magnetic core material (e.g., silicon steel, iron) of an electric machine represents the maximum magnetic flux density (B) that the material can achieve before it becomes saturated and behaves like air. Bsat is generally the point on the B-H magnetization curve where increasing the magnetic field strength (H) results in little to no further increase in the magnetic flux density (B). Operating an electric machine near Bsat ensures the material is used efficiently, allowing for a smaller, lighter machine (high power density). Bsat is often considered to set the upper limit for the magnetic performance of the electric machine's core. Therefore, it is desirable for a stator core to be associated with a high Bsat value. Unfortunately, while thin lamination layers tend to reduce eddy currents, the thin lamination layers also tend to decrease the Bsat of the core.

It would be advantageous to improve on the construction of the stator core by further reducing eddy current losses and thereby making the stator even more efficient. It would also be advantageous to improve the construction of the stator core by increasing the saturation flux density of the of the thin material used to form the core. Additionally, it would be beneficial if such a core for an electric machine could be produced easily and relatively inexpensively.

### SUMMARY

In at least one embodiment disclosed herein, a core for an electric machine is comprised of foil sheets. The core defines an outer diameter and a plurality of inwardly extending teeth with slots formed between the teeth. The core is provided by a lamination stack comprising a plurality of lamination sheets. Each lamination sheet of the core is formed from a substack of a plurality of foil sheets that are bonded together to form the lamination sheet. Each foil sheet of the plurality of foil sheets in each substack has a thickness that is less than fifty microns. Each lamination sheet is separated from an adjacent lamination by an insulation layer.

In accordance with at least one embodiment of the disclosure, a method is disclosed for making a core for an electric machine. The method includes forming a plurality of individual lamination sheets and then stacking the plurality of lamination sheets to form the core. Each of the plurality of individual lamination sheets is formed by a substack of a plurality of foil ribbons, wherein each of the plurality of ribbons has a thickness of less than fifty microns. The method includes bonding the plurality of foil ribbons together to form a lamination sheet for the core that is greater than seventy-five microns. The method further includes applying an insulation layer to each lamination sheet. The insulation layer may be pre-coated on one of the plurality of ribbons or applied to the substack that forms the lamination sheet. After forming the substack, the lamination sheet is formed into a shape associated with the core. The plurality of lamination sheets are then stacked upon one another to form at least a portion of the core for the electric machine.

The above-described features and advantages, as well as others, will become more readily apparent to those of ordinary skill in the art by reference to the following detailed description and accompanying drawings. While it would be desirable to provide a stator core that provides one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows a perspective view of a stator core for an electric machine;

FIG. 2A shows an elevational view of strips of foil in a laminated and overlapped design, the strips of foil used to form lamination sheets for the stator core of FIG. 1;

FIG. 2B shows a plan view of the strips of foil of FIG. 2A;

FIG. 3A shows an example of the stator core formed using the lamination sheets of FIGS. 2A and 2B, the stator core provided as a complete annular stator core;

FIG. 3B shows an example of a piece of a puzzle-piece stator formed using the lamination sheets of FIGS. 2A and 2B;

FIG. 4 shows a chart of ribbon thickness v. saturation flux density (Bsat) for an electric machine;

FIG. 5 shows a chart illustrating the tradeoff between an electric machine having a thin ribbon core with reduced eddy current losses but a lowered saturation flux density;

FIG. 6 shows a perspective view of two lamination sheets of an electric machine core, each lamination sheet provided by four non-insulated foil ribbons and one insulated foil ribbon welded together to form fused sublayers;

FIG. 7 is a diagram illustrating a melt spinning process used to form the strips of foil of FIGS. 2A and 2B; and

FIG. 8 is a block diagram of a method of manufacturing a stator core using the strips of foil of FIGS. 2A and 2B.

### DESCRIPTION

With reference now to the figures, a core for an electric machine (e.g., a stator core) is disclosed that incorporates thin laminations and a high silicon material in order to reduce eddy current losses. The core is made of a plurality of lamination sheets, each lamination sheet formed from a plurality of foil ribbons that are fused together. The foil ribbons are comprised of an extremely thin magnetic-permeable material such as super thin Ductile High Silicon Steel (DHSS). In at least some embodiments, the foil ribbons are only ten to fifty microns thick and twenty-five to fifty mm wide. In at least some embodiments, the foil ribbons are between ten and forty microns thick.

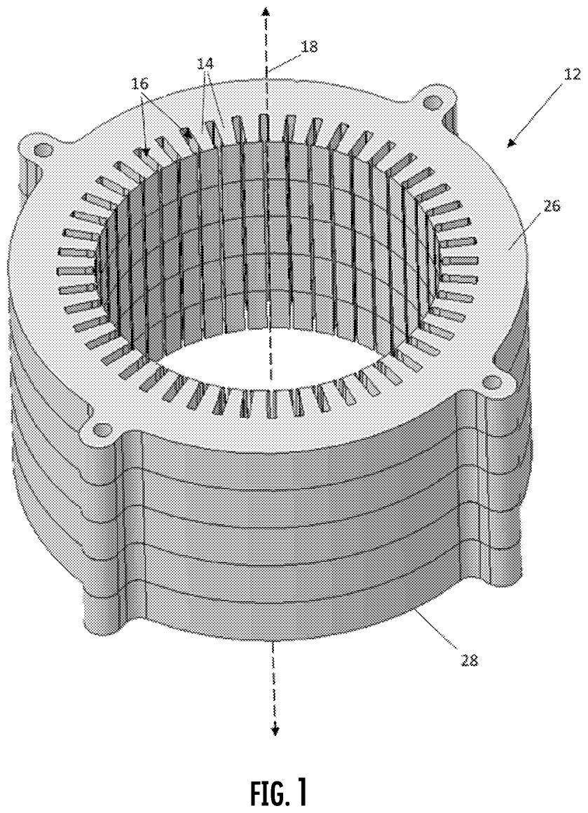

In at least one embodiment, the core is a stator core 12 such as that shown in FIG. 1. The stator core 12 is comprised of a magnetic-permeable material and is formed from a plurality of laminations sheets that are formed to a desired shape and stacked upon one another to form a lamination stack. As explained in further detail below, each lamination sheet for the stator core 12 is comprised of a substack of foil ribbons that are fused together, as described in further detail below.

The stator core 12 is generally cylindrical in shape as defined by a center axis 18, and includes an inner perimeter surface and an outer perimeter surface. The inner perimeter surface defines an inner diameter (ID) for the stator. The outer perimeter surface defines an outer diameter (OD) for the stator. The stator core is formed with a plurality of teeth 14 arranged on the interior of the stator core 12 and directed inwardly toward the center axis 18. Each tooth 14 extends radially inward and terminates at the inner perimeter surface. Axial slots 16 are formed in the stator core 12 between the teeth 14. Each slot 16 is defined between two adjacent teeth, such that two adjacent teeth form two opposing radial walls for one slot. The teeth 14 and slots 16 all extend from a first end 26 to a second end 28 of the core.

The slots 16 may be open or semi-closed along the inner perimeter surface of the stator core 12. When the slots 16 are semi-closed, each slot 16 has a width that is smaller at the inner perimeter surface than at more radially outward positions (i.e., slot positions closer to the outer perimeter surface). When the slots are open, conductors may be inserted into the slots from the ID. In addition to the radial openings to the slots 16 through the inner perimeter surface (i.e., for open and semi-closed slots), axial openings to the slots 16 are also provided the opposite ends 26, 28 of the stator core 12.

The stator core 12 is configured to retain a winding arrangement (not shown) within the slots 16 of the stator core 12. The winding arrangement is formed from a plurality of interconnected coils that are retained within the slots 16. The coils are comprised of multiple segments of copper or other electrically conductive material that form poles for the windings. The conductors extend through the slots and wrap around the teeth of the core, as will be recognized by those of ordinary skill in the art. An exemplary winding arrangement is disclosed in U.S. Pat. No. 12,231,000, issued Feb. 18, 2025, the entire contents of which are incorporated by reference herein.

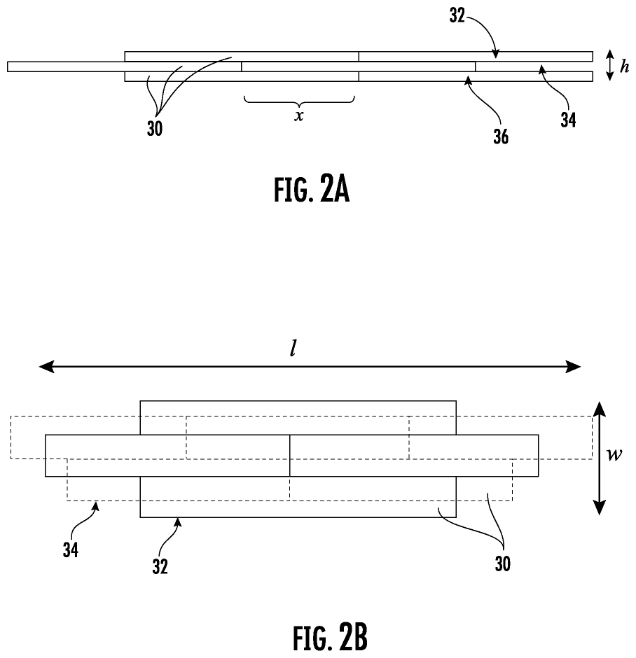

With reference now to FIGS. 2A and 2B, an arrangement of foil sheets 30 in an exemplary lamination sheet of a stator core is shown. Each foil sheet is comprised of a magnetic-permeable material, such as a super thin Ductile High Silicon Steel (DHSS). Each foil sheet has a length dimension, a width dimension, and a height (i.e., thickness) dimension. The length dimension is typically greater than the width dimension, and the width dimension is much greater than the depth dimension. For example, the length or width dimension may be in the magnitude of a thousand times greater than the height dimension. In at least some embodiments, the foil sheet is less than fifty (50) microns thick. For example, the foil sheet may be between ten (10) microns and forty (40) microns thick, or between twenty (20) and thirty (30) microns, and/or more specifically about twenty-five (25) microns thick (i.e., 25 microns +/−5 microns). The foil may also be made in strips of material which are twenty-five to fifty mm wide. Because the length of each foil sheet is typically elongated and at least somewhat greater than the width of the foil sheet 30, each foil sheet 30 may also be referred to herein as a “foil ribbon” or a “foil strip.” This elongated ribbon structure of the foil sheet may be result of a manufacturing process, such as a melt spinning process used to create the foil sheet as a foil ribbon, as described in further detail below in association with FIG. 7.

With continued reference now to FIG. 2A, individual foil ribbons 30 are stacked on top of one another to form one lamination sheet 40 of the stator core 12. Stacking the foil ribbons 30 has the advantage of providing additional breaks between individual sheets of material in the stator core which further reduces eddy currents. However, potential issues with the foil strips 30 may include the following:
(1) Laminations of the core of an electric machine are typically made from a stamping process because the stamping process is quick and inexpensive. However, the foil is typically too thin to use a stamping operation (i.e., stamping an individual sheet of foil will typically deform the foil and does not result in a precise shape of the stamped sheet).
(2) The foil is so thin that insulation layers on the foil will cause the stacking factor to be very low which reduces the amount of steel in a given lamination stack of a certain axial length. Reducing the amount of steel in the lamination stack results in a reduced saturation flux density (Bsat) for the core which is consequently bad for motor performance.
(3) The foil strip width is typically twenty-five (25) to fifty (50) mm wide strips, but many outer diameters for electric machine cores are much greater than this. For example, stator cores for traction motors are typically 220 mm or larger.
To address issues #1 and #3 above, the foil strips are assembled together using a Laminated Object Manufacturing (LOM) process where the strips are laminated and overlapped with each other. FIG. 2A shows a side view of an exemplary embodiment wherein a plurality of foil strips are stacked together in three layers 32, 34, 36, and offset from one another to form an object 40 that provides a lamination sheet for the stator core. As shown in FIG. 2A, the foil sheets 30 in an upper layer 32 and a lower layer 36 are offset in a length direction from the foil sheets 30 in the middle layer 34 by a distance “x”. FIG. 2B shows a plan view of the lamination sheet of FIG. 2A with the foil strips in the upper layer 32 shown in solid lines and the foil strips in the middle layer 34 shown in dotted lines (note the foil sheets in the lower layer 36 are not shown for the sake of simplicity). As noted by the contrasting solid and dotted lines, the foil strips 30 in the upper layer 32 are offset from the foil strips in the middle layer 34 in a length direction (l) and a width direction (w).

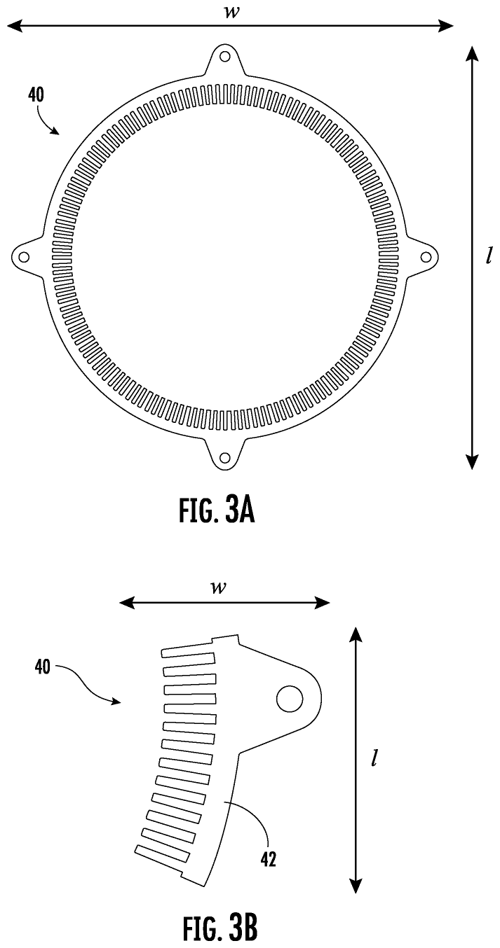

LOM objects can be formed by bonding the foil strips 20 together using an adhesive or a welding process (e.g., adhered or welded together). As a result of overlapping the foil strips 20, the assembled LOM object 40 can be large enough to make the complete annular stator lamination shape in one piece (e.g., greater than 220 mm), such as that shown in FIG. 3A. In this case, since the annular stator has a large hole in the middle, the object of the raw material formed from the LOM may be formed with a large hole in the middle to reduce waste material. Alternatively, the assembled LOM object 40 may be smaller (e.g., less than 75 mm) to make only a portion of the stator lamination shape, such as that shown in FIG. 3B. When the LOM object is smaller, the individual portions of the stator lamination are assembled together like a puzzle to form the complete annular lamination shape (i.e., a “puzzle-piece” stator is formed by assembling the individual LOM objects which are provided as puzzle-piece objects 42). In either case, he LOM object is formed with a sufficient number of layers to allow the stamping process to be performed without damaging the LOM object.

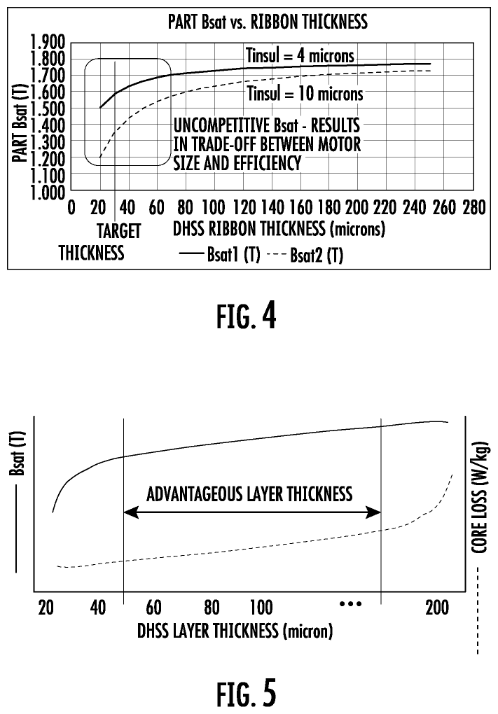

With respect to issue #2 above, it has been determined that the thickness of the insulation layers applied to the foil is helpful toward increasing the saturation flux density for the stator core. As shown in FIG. 4, the ribbon thickness is on the X-axis and the saturation flux density (Bsat) is on the Y-axis. Two curves are shown: the upper curve with four (4) microns of insulation thickness on each ribbon, and the lower curve with ten (10) microns of insulation thickness on each ribbon. For the typical DHSS ribbon thicknesses of ten (10) microns to forty (40) microns (as highlighted by the rectangular box in the graph) there is a very large degradation of Bsat due to the insulation displacing steel in a given stack height. For example, if the insulation is five (5) microns thick and the foil is twenty-five (25) microns thick, and the insulation is coated on both sides of the steel, then the stack will be comprised of 23% insulation (2×10/45) and only 77% steel foil. Consequently, Bsat will fall from 1.8 T to 1.39 T. Therefore, in order to increase Bsat, it has been determined that it is advantageous to limit the amount of insulation associated with each foil ribbon 30 and the associated lamination sheets formed from a plurality of foil ribbons.

As noted previously, super thin DHSS foil ribbon has the benefit of being thin to reduce eddy current losses but the downside of lowering saturation flux density (Bsat) in the stator core. FIG. 5 represents this tradeoff graphically. In FIG. 5, DHSS foil ribbon thickness is on X-axis, Bsat (in units of Tesla (T)) is on the left Y-axis and displayed by the upper curve, and Core Loss (in units of W/kg) is on Y axis and displayed by the lower curve. As shown in FIG. 5, there is a range of ribbon thickness from fifty (50) microns to one hundred fifty (150) microns (represented by the length of the curves between the two vertical lines) which has a satisfactory Bsat (not too low) and a satisfactory core loss (not too high). These portions of the curves are identified as being associated with an “advantageous layer thickness” in FIG. 5.

While advantageous layer thicknesses are identified in FIG. 5, DHSS foil ribbon may be only available for a manufacturer in something lower than fifty (50) microns (e.g., 25 microns). Therefore, it has been determined that the thickness of a foil ribbon that is too thin may be increased by layering the uninsulated ribbon. This is accomplished by creating a substack of foil ribbon layers (e.g., as shown in FIGS. 2A and 2B) wherein the substack is thicker than a single foil ribbon layer, and then adding an insulation layer (such as C4, C5, oxide, C4a, C5a . . . etc.) to each of the substacks of foil ribbons before assembling the substacks as lamination layers on the core. For example, assume a DHSS foil ribbon thickness of twenty-five (25) microns and a desired lamination thickness of seventy-five (75) microns (i.e., a thickness within the “advantageous layer thickness” noted in FIG. 5). If three of the twenty-five (25) micron foil ribbons are stacked together, an object (i.e., a substack of foil ribbon layers) is formed which is three (3) layers thick, resulting in a seventy-five (75) micron total thickness. In this example, each of the foil ribbon layers may be overlapped with adjacent layers (as described previously herein) and laminated (i.e., bonded together using heat or other means) to form the object. This object is then coated with a coating (e.g., C4 classification based on ASTM A976 standards) either to one side or both sides. A plurality of C4 coated, seventy-five (75) micron thick, objects are then made, each configured to provide one layer of the lamination stack for the stator core. The objects may then be stacked and assembled to form the complete stator core. As noted previously, the objects may be in the shape of an entire stator core (i.e., each object is sufficiently long and wide to cover an entire OD of the stator core), or may be puzzle pieces that are fit together and bonded to create the entire stator core (i.e., each object only covers a partial arc of the entire stator core).

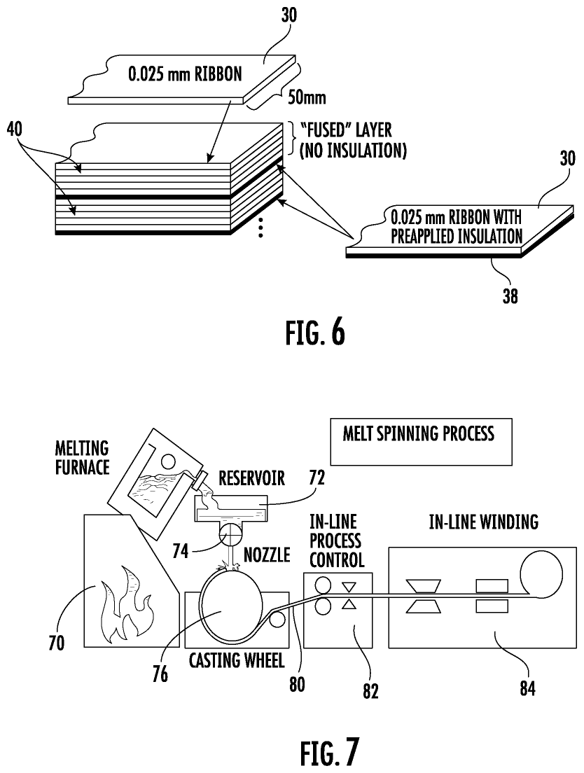

FIG. 6 shows an example of objects 40 formed by the LOM procedure, wherein each object is used as a layer of the lamination stack of the stator. As shown in FIG. 6, each layer is comprised of a substack of five foil ribbons that are bonded together (e.g., by welding, adhesive or other bonding). Welding is particularly advantageous for the LOM procedure because the welding of adjacent foil strips forms a contiguous object formed from the ribbons. More specifically, ultrasonic welding may be used wherein the foil ribbons are ultrasonically vibrated with respect to each other to form a complete bond/weld of the face of one ribbon to the face of the other ribbon. The ultrasonic weld process may also remove any oxide layers between the two ribbons.

FIG. 6 shows two layers 40 of a lamination stack for a stator core 12. Each layer 40 of the lamination stack (i.e., each of the formed objects) includes four non-insulated twenty-five micron foil ribbons 30 welded together with a fifth twenty-five micron foil ribbon 30 with pre-applied insulation 38 on one side. Each substack of five foil ribbons 30 with pre-applied insulation 38 on one foil ribbon forms one layer 40 of the lamination stack for the stator core 12. It will be recognized that, in at least some embodiments, the insulation 38 may be pre-applied to a ribbon 30 of the object 40, while in other embodiments the insulation 38 may be post applied to one side (or both sides) of the object 40. As a result of the insulation coating, each lamination sheet is separated from an adjacent lamination sheet by an insulation layer

In addition to the above, it will be noted that a thin natural layer (e.g., <10 nanometers) of oxide may exist on the foil ribbons 30 that are considered to be non-insulated. In order to further reduce eddy currents in the stator core 12, the oxide layer could also be increased (e.g., >10 nanometers) by using heat and time to form additionally insulated foil ribbons 30.

After each object 40 is formed with multiple layers of foil ribbons, further processing occurs to shape the object into the cross-sectional shape of the stator core 12 or a portion of the stator core (in the event of a puzzle-piece stator). The process to form the objects into the lamination shapes may be any appropriate shaping process, such as stamping, computer numerical control (CNC) machining, electrical discharge machining (EDM) laser cut or any similar process. In the case of stamping, the object 40 must be sufficiently thick to after the LOM process to allow for stamping. While shaping of the foil ribbons 30 to the desired shape of the stator core 12 is described herein as being performed at the object/substack level, it will be recognized that shaping of the foil ribbons may alternatively be performed at the ribbon level (e.g., with EDM laser cutting) or at the lamination stack level (e.g., with CNC machining).

In at least some instances, the DHSS foil ribbons used to form the stator are commercially available to the stator manufacturer. In other instances, the DHSS foil ribbons may be produced by the manufacturer of the stator. In such situations, the process to make the ribbons may be hot melt spinning process such as that illustrated in FIG. 7. The process involves a melting furnace 70 that is used to create molten DHSS. The molten DHSS is retained in a reservoir 72 and fed through a nozzle 74 onto a casting wheel 76. The molten DHSS is cooled on the casting wheel 76 and forms a foil 80. The foil 80 is fed as a ribbon of material to an in-line process control station 82 where the foil is further cooled and processed. A coating of insulation, if appropriate, may also be applied to the foil 80 at the control station 82. Thereafter, the foil is fed to an in-line winding station 84 where the foil is wound on a spool for storage and subsequent use. The manufactured foil ribbon may have an advantageously high silicon content. For example, the foil ribbon may be 3.5% silicon for low loss and relatively high Bsat, or the foil ribbon may be 6.5% silicon for even lower core losses.

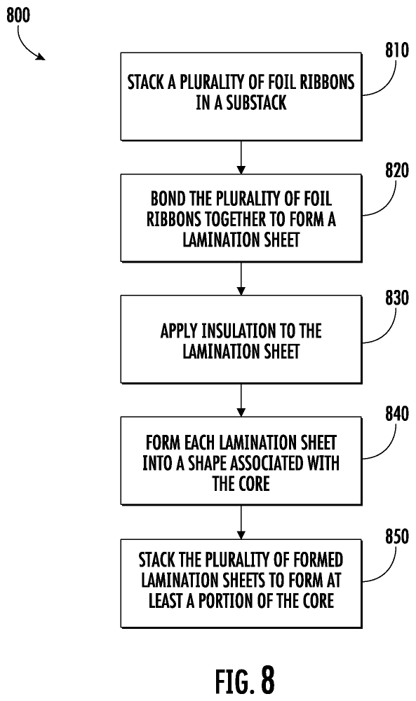

In view of the foregoing, it will be recognized that a method of making a stator core is disclosed herein. As shown in FIG. 8, the method 800 includes forming a plurality of lamination sheets for the stator core. The steps of forming the plurality of lamination sheets includes first stacking a plurality of foil ribbons into a substack, as noted in block 810 of the method. As discussed previously each of the plurality of foil ribbons has a thickness of less than fifty microns. In at least some embodiments each of the plurality of foil ribbons has a thickness between twenty and forty microns, and the plurality of foil ribbons are overlapped in different layers on the substack. The foil ribbons may be overlapped in a height, a length, and a width direction.

Next, as noted in block 820, the method continues by bonding the plurality of foil ribbons together using a process such as ultrasonic welding. The ultrasonic welding may occur each time a new foil ribbon is added to the substack. When all of the foil ribbons are added to the substack, a lamination sheet for the core is formed that is greater than seventy-five microns in thickness. In at least some embodiments, the lamination sheet for the core is also less than two hundred microns.

As noted in block 830, the method further includes applying insulation to the lamination sheet. The insulation may be applied by coating one of the individual foil ribbons with insulation prior to adding it to the substack, or applying insulation to one of the outer layers of the substack once it is formed.

As noted in block 840, the method further includes forming each lamination sheet into a shape associated with the core. Forming the lamination sheet into a shape associated with the core may include stamping the lamination sheet, CNC machining the lamination sheet, or EDM laser cutting the foil ribbons and/or lamination sheet.

In block 850, the method continues by stacking the plurality of formed lamination sheets to form at least a portion of the core for the electric machine. In at least some of the embodiments, each of the plurality of lamination sheets extends across an entire diameter of the core. In other embodiments, each of the plurality of lamination sheets extends across a partial diameter of the core such that the stacked lamination sheets form puzzle portions of the core. In these embodiments, the puzzle portions are then arranged and bonded together to form the complete core.

The foregoing detailed description of one or more embodiments of the stator lamination made of steel foil has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by any appended claims. Therefore, the spirit and scope of any appended claims should not be limited to the description of the embodiments contained herein.

What is claimed:

1. A core for an electric machine, the core defining an outer diameter and a plurality of inwardly extending teeth with slots formed between the teeth, the core comprising:
a lamination stack comprising a plurality of lamination sheets, each lamination sheet of the plurality of lamination sheets comprising a substack of a plurality of foil sheets bonded together to form the lamination sheet, each foil sheet of the plurality of foil sheets in each substack having a thickness of less than fifty microns, wherein each lamination sheet is separated from an adjacent lamination sheet by an insulation layer.

2. The core of claim 1 wherein each of the plurality of foil sheets has a thickness of at least twenty microns, and wherein each lamination sheet has a thickness between seventy-five and two hundred microns.

3. The core of claim 2 wherein the foil sheets in the substack of the plurality of foil sheets are welded to adjacent foil sheets in the substack of the plurality of foil sheets.

4. The core of claim 3 wherein the plurality of foil sheets are a plurality of foil ribbons arranged on the substack overlapping in a height, width, and depth direction.

5. The core of claim 4 wherein each foil ribbon has a width between fifty and seventy-five mm.

6. The core of claim 5 wherein each foil ribbon is comprised of a super thin ductile high silicon steel (DHSS) material.

7. The core of claim 1 wherein a plurality of foil ribbons in the substack of the plurality of foil sheets are adhered together with an adhesive.

8. The core of claim 1 wherein each of the plurality of foil sheets has a thickness between ten microns and forty microns.

9. A method of making a core for an electric machine comprising:
forming a plurality of lamination sheets, wherein each of the plurality of lamination sheets is formed by:
stacking a plurality of foil ribbons, each of the plurality of foil ribbons having a thickness of less than fifty microns;
bonding the plurality of foil ribbons together to form a lamination sheet for the core that is greater than seventy-five microns;
applying insulation to the lamination sheet; and
forming the lamination sheet into a shape associated with the core; and
stacking the plurality of formed lamination sheets to form at least a portion of the core for the electric machine.

10. The method of claim 9 wherein bonding the plurality of foil ribbons together comprises ultrasonic welding of the plurality of foil ribbons such that the plurality of foil ribbons are fused together.

11. The method of claim 9 wherein each of the plurality of foil ribbons has a thickness between ten microns and forty microns and each lamination sheet has a thickness between seventy-five and two hundred microns.

12. The method of claim 9 wherein stacking the plurality of foil ribbons comprises stacking the plurality of foil ribbons such that the plurality of foil ribbons are overlapped in different layers of each lamination sheet, and wherein the plurality of foil ribbons are overlapped in a height, a length, and a width direction of each of the plurality of lamination sheets.

13. The method of claim 9 wherein forming the lamination sheet into a shape associated with the core includes at least one of stamping the lamination sheet, computer numerical control (CNC) machining the lamination sheet, and electrical discharge machining (EDM) laser cutting the lamination sheet.

14. The method of claim 9 wherein the lamination sheet is formed by laminated object manufacturing (LOM).

15. The method of claim 9 wherein applying insulation to the lamination sheet includes applying an insulation coating to at least one side of the lamination sheet.

16. The method of claim 15 wherein the insulation coating is a C4, a C5 or an oxide coating.

17. The method of claim 15 wherein each of the formed lamination sheets includes at least three layers of foil ribbons, and wherein the insulation coating separates each of the formed lamination sheets.

18. The method of claim 9 wherein each of the plurality of foil ribbons is comprised of a super thin ductile high silicon steel (DHSS) material formed by a melt spinning process.

19. The method of claim 9 wherein each of the plurality of lamination sheets extends across an entire diameter of the core.

20. The method of claim 9 wherein each of the plurality of lamination sheets extends across a partial diameter of the core, and wherein stacking the plurality of formed lamination sheets comprises forming puzzle portions of the core from the plurality of lamination sheets and bonding the puzzle portions together to form the core.
